(19) United States
(12) Patent Application Publication
(10) Pub. No.: US 2010/0189493 A1
(43) Pub. Date: Jul. 29, 2010

(54) SPACER SEALANT ARTICLES

(75) Inventors: Eric Aldstadt, Novi, MI (US); Craig Haase, Macomb Township, MI (US); David Franey, Wyandotte, MI (US)

Correspondence Address: HENKEL CORPORATION, One Henkel Way, ROCKY HILL, CT, 06067, US

(73) Assignee: Henkel AG & Co. KGaA, Duesseldorf (DE)

(21) Appl. No.: 12/693,871

(22) Filed: Jan. 26, 2010

Related U.S. Application Data
(63) Continuation of application No. PCT/US2008/009055, filed on Jul. 25, 2008.
(60) Provisional application No. 60/952,664, filed on Jul. 30, 2007.

(51) Int. Cl. F16B 7/04; F16J 15/02

(52) U.S. Cl. 403/168; 277/640

(57) ABSTRACT

Spacer sealant articles are provided that are useful in fastening one substrate to another by means of bolts or the like where it is desired to maintain a spacing between the substrates and yet seal around a bolt or the like that extends from one substrate through the other substrate. Such articles contain a) a heat resistant polymeric spacer element and b) a sealant element surrounded by said spacer element, wherein the sealant element has at least one through hole therein.

This application is a continuation under 35 U.S.C. Sections 365(c) and 120 of International Application No. PCT/US2008/009055, filed Jul. 25, 2008 and published on Feb. 5, 2009 as WO 2009/017674, which claims priority from U.S. Provisional Patent Application Ser. No. 60/952,664 filed Jul. 30, 2007, which are incorporated herein by reference in their entirety.

### FIELD OF THE INVENTION

The present invention pertains to spacer sealant articles that are useful in fastening one substrate to another by means of bolts or the like where it is desired to maintain a spacing between the substrates and yet seal around a bolt or the like that extends from one substrate through the other substrate.

### DISCUSSION OF THE RELATED ART

Currently, hinge brackets are attached to vehicle bodies using a spacer fabricated from cork or a similar material to maintain a desired offset gap (typically about 1 mm) between the hinge to the bolt nuts and the body of the vehicle. Such an assembly also requires that a seal be applied around the periphery of the hinge to prevent water from penetrating into the hinge and bolt areas. This current approach has a high rate of failure due to water leaks and also requires extensive labor. Additionally, the applied seal is often quite visible and therefore can be aesthetically unappealing. It would therefore be desirable to develop alternative, improved methods of effectively sealing automotive hinge brackets while maintaining the required offset gap.

### BRIEF SUMMARY OF THE INVENTION

In one aspect, the invention provides a spacer sealant article comprising a) a heat resistant polymeric spacer element and b) a sealant element surrounded by said spacer element, wherein said sealant element has at least one through hole therein. In another aspect, the invention provides an assembly comprised of such a spacer sealant article and a substrate having a base and at least one post extending from said base, wherein said at least one post extends through said at least one through hole. In yet another aspect of the invention, a method of fastening a first substrate to a second substrate is provided, said method comprising: a). providing said first substrate with at least one post extending therefrom; b). providing said second substrate with at least one through hole; c). providing a spacer sealant article comprising i) a heat resistant polymeric spacer element and ii) a sealant element surrounded by said spacer element, wherein said sealant element has at least one through bole therein; d). inserting said at least one post through said at least one through hole of said article and said at least one through hole of said second substrate; e). bringing said first substrate, said article and said second substrate into close conformance with each other; and f). heating said sealant element to a temperature effective to cause said sealant element to soften and flow, said temperature being selected so as to avoid softening of the spacer element.

In the context of the present invention, the term “surrounded by” means that the sealant element is encircled by the spacer element, with at least one surface of the sealant element nonetheless possibly remaining available to be brought into contact with the first or second substrate surface, as will be explained in more detail hereafter.

The invention thus provides one or more of the following benefits or advantages:
Prevents water leaks through the use of a heat-activated sealant element incorporated into the spacer element.
Reduces the amount of labor required at an automotive assembly plant to install hinge brackets.
Eliminates the need to separately apply a secondary sealant around the hinge assembly, thereby simplifying assembly and providing a finished assembly having enhanced aesthetic appearance.
Use of a heat-resistant spacer element, which can be easily molded to the desired dimensions using a glass fiber-filled thermoplastic, permits the desired offset gap to be created while also meeting torque drop requirements.

### BRIEF DESCRIPTION OF THE DRAWINGS

FIG. 1 is a perspective view of one embodiment of a spacer sealant article in accordance with the present invention.

FIG. 2 is a perspective view showing how the spacer sealant article of FIG. 1 can be utilized in joining a first substrate to a second substrate.

FIG. 3 is a cross-sectional representation of the assembly obtained by using a spacer sealant article in accordance with the present invention to join together two substrates, before activation of the sealant element by heating.

FIG. 4 is a perspective view of another embodiment of a spacer sealant article in accordance with the present invention.

### DETAILED DESCRIPTION OF CERTAIN EMBODIMENTS OF THE INVENTION

The sealant element of the present invention should be selected to be a melt flowable material which is solid and dimensionally stable at room temperature (15 to 25 degrees C.) and yet is capable of softening and flowing when heated to a higher temperature. “Dimensionally stable” means that the sealant element does not flow and maintains its shape in the absence of any forces other than gravity. In one embodiment of the invention, the sealant element is non-tacky at room temperature. A non-tacky sealant element has the advantage of being easily handled and does not need to be protected from contamination or blocking through the use of a temporary protective film or the like. In another embodiment, however, the sealant element may be tacky at room temperature, wherein the tackiness of the sealant element surface may be utilized to temporarily hold the spacer sealant article in place on a substrate surface prior to activation of the sealant element by heating. Prior to application of the sealant element surface to the substrate surface, a release film or the like may be used to protect the sealant element surface.

The sealant element is formulated to be sufficiently thermoplastic such that it softens and flows when heated, thereby performing the desired sealing function. The sealant element may remain thermoplastic after heating and cooling or may be thermosettable or reactive such that upon heating to an elevated temperature it undergoes a crosslinking or curing reaction, thereby yielding a thermoset that is resistant to softening and flowing when reheated. Preferably, the material utilized to form the sealant element is moldable, in particular injection moldable. In one embodiment of the invention, the sealant element material is thermoplastic up to a particular temperature (thereby allowing the material to be formed into a sealant element having a desired shape by molding and allowing the sealant element to be melt flowable), but undergoes curing or crosslinking, thereby becoming thermoset, when heated to a second, higher temperature.

In one embodiment of the invention, the melt flowable material is selected such that the sealant element softens and flows at the temperatures experienced when a vehicle is subjected to heating during the process used to coat or paint the vehicle (for example, when the vehicle is baked in an e-coat oven, sealer oven, primer surfacer oven, and/or paint oven). The heating cycle experienced by an assembly containing a spacer sealant article in accordance with the invention may, for example, be as follows:

| | | |
|---|---|---|
| a. | E Coat Oven | 40-60 minutes at 175-205 degrees C. |
| b. | Sealer Oven | 15-25 minutes at 150-175 degrees C. |
| c. | Primer Surfacer Oven | 35-55 minutes at 155-185 degrees C. |
| d. | Top Coat Oven | 30-50 minutes at 160-190 degrees C. |

Generally speaking, the melt flowable material is comprised of one or more polymers or polymer precursors, with at least one of such polymers or polymer precursors being thermoplastic in character. The polymer(s) may be crystalline, semi-crystalline or amorphous, with the glass transition temperature, softening point and/or melting point being selected so as to impart the desired properties to the formulated melt flowable material. For example, the polymer(s) may be chosen to provide the desired combination of melt flow properties, noise and vibration dampening properties, chemical/solvent/water resistance and/or sealing and adhesive properties.

Thermoplastics, including thermoplastic elastomers, are particularly suitable for use in the sealant element. Such substances are well known in the art and include, for example, olefin polymers and copolymers (e.g., polyethylene, polypropylene, ethylene/alpha-olefin copolymers, including those copolymers obtained by metallocene-catalyzed copolymerization of ethylene and one or more higher olefins, ethylene/vinyl acetate copolymers, ethylene/(meth)acrylic acid copolymers, and ethylene/alkyl acrylate copolymers), polyvinyl acetates, homopolymers and copolymers of vinyl aromatic monomers such as polystyrene, block copolymers of vinyl monomers such as styrene and diene monomers such as butadiene and isoprene, polyvinyl chloride, polyacrylates (e.g., acrylic homopolymers and copolymers, including homopolymers and copolymers of C1-C12 alkyl acrylates and/or methacrylates, where such monomers may be copolymerized with other types of ethylenically unsaturated monomers such as vinyl aromatic monomers and (meth)acrylic acid), styrene/(meth)acrylic acid copolymers, polyurethanes, polyesters, polyamides, polyacetals, and the like. Rubbers and other elastomers are also suitable for use as components of the sealant element including, for example, styrene/butadiene rubbers (SBR), nitrile/butadiene rubbers (NBR), ethylene/propylene/diene monomer (EPDM) rubbers, styrene/isoprene copolymers, polychloroprene rubbers, polyisoprene rubbers, polybutadiene rubbers, and the like.

Any of the aforementioned polymers may be functionalized, either through copolymerization with a functionalized comonomer and/or through post-polymerization modification of the polymer with a functional compound in a grafting reaction or the like. The functional groups thereby introduced may be, for example, carboxylic acid groups, carboxylic acid anhydride groups, hydroxyl groups, amine groups, epoxy groups, or the like and may serve to modify the physical and/or chemical properties of the polymer and/or the melt flowable material prepared therefrom. For example, the functional groups may increase the heat resistance or solvent resistance of the polymer or improve its flow, adhesive or sealing characteristics or serve as a reactive site through which the polymer can be further modified by crosslinking, curing or the like.

Polymer precursors suitable for use in the present invention include, for example, epoxy resins (especially epoxy resins that are solid at room temperature), polyurethane prepolymers (especially polyurethane prepolymers that are solid at room temperature), and other substances capable of being reacted to form polymeric matrices, either by themselves or in combination with curing agents, catalysts and the like. Such reaction may be accomplished when the sealant element is heated, for example.

Any of the epoxy resins having an average of more than one (preferably about two or more) epoxy groups per molecule known or referred to in the art may be utilized as the epoxy resin component.

Epoxy resins are described, for example, in the chapter entitled “Epoxy Resins” in the Second Edition of the Encyclopedia of Polymer Science and Engineering, Volume 6, pp. 322-382 (1986). Exemplary epoxy resins include polyglycidyl ethers obtained by reacting polyhydric phenols such as bisphenol A, bisphenol F, bisphenol AD, catechol, resorcinol, or polyhydric alcohols such as glycerin and polyethylene glycol with haloepoxides such as epichlorohydrin; glycidylether esters obtained by reacting hydroxycarboxylic acids such as p-hydroxybenzoic acid or beta-hydroxy naphthoic acid with epichlorohydrin or the like; polyglycidyl esters obtained by reacting polycarboxylic acids such as phthalic acid, tetrahydrophthalic acid or terephthalic acid with epichlorohydrin or the like; epoxidated phenolic-novolac resins (sometimes also referred to as polyglycidyl ethers of phenolic novolac compounds); epoxidated polyolefins; glycidylated aminoalcohol compounds and aminophenol compounds, hydantoin diepoxides and urethane-modified epoxy resins. Mixtures of epoxy resins may be used if so desired; for example, mixtures of liquid (at room temperature), semi-solid, and/or solid epoxy resins can be employed. Any of the epoxy resins available from commercial sources are suitable for use in the present invention. Preferably, the epoxy resin has an epoxide equivalent molecular weight of from about 150 to 3000. The use of epoxy resins based on glycidyl ethers of bisphenol A is especially advantageous.

Although at least one of the polymers or polymer precursors is preferably thermoplastic (solid at room temperature and, preferably, at temperatures up to 50 degrees C., with the capability of being softened or melted and thereby rendered flowable by heating to a higher temperature and then resolidified by cooling to room temperature), the melt flowable material may additionally contain one or more polymers or polymer precursors that are liquid or semi-solid at room temperature. Such liquid or semi-solid polymers or polymer precursors may be compositionally similar to the solid polymers and polymer precursors mentioned above, but differing in other characteristics such as molecular weight, for example (e.g., liquid polybutadienes, liquid acrylonitrile/butadiene copolymers, liquid or semi-solid epoxy resins, liquid polyurethane prepolymers).

The sealant element of the invention may, in one embodiment of the invention, be expandable, that is, capable of being expanded (foamed) when heated. An expandable sealant element may help to ensure that complete sealing around a bolt or the like is attained when the sealant element is activated by heating. That is, the expansion of the sealant element will tend to force the melt flowable material into any opening or gap initially present between the through hole in the sealant element and the post that extends through such hole. Sealing of at least part of the space that may initially exist between the post and the holes in the first and/or second substrates through which the post extends may also be achieved. The sealant element may be rendered expandable through the incorporation of one or more blowing agents. Selection of the blowing agent or blowing agents is not believed to be particularly critical, with both chemical blowing agents as well as physical blowing agents being suitable and with latent (heat-activated) blowing agents being particularly preferred. Preferred blowing agents include expandable hollow plastic microspheres, wherein a shell comprised of a polymer such as a polyvinylidene chloride copolymer or an acrylonitrile/(meth)acrylate copolymer encapsulates a volatile blowing agent such as a lower alkyl hydrocarbon. Any of the chemical blowing agents known in the art may also be employed, such, as for example, azo compounds (e.g., azodicarbonamide), hydrazides (e.g. sulfonylhydrazides), and the like. The activation temperature of the blowing agent is preferably selected in coordination with the softening temperature of the melt flowable material used for the sealant element, so that the foaming is induced at a temperature where the sealant element is sufficiently soft so as to permit controlled expansion of the melt flowable material. However, it will generally be desirable to select a blowing agent that is not activated at the temperature at which the melt flowable material is to be shaped into the sealant element (e.g., by injection molding).

In addition to the above-mentioned components, the melt flowable material used to fabricate the sealant element may contain one or more of the additives or ingredients conventionally used in the formulation of melt flowable (e.g., hot melt) adhesives and sealants. Such additives include, for example, plasticizers, curing agents, crosslinking agents, tackifiers, adhesion promotion agents, stabilizers, fillers, pigments, accelerators, waxes, catalysts, and the like.

In one embodiment of the invention, the melt flowable material used to make the sealant element is selected so as to provide effective corrosion resistance when coated onto or in contact with a metal surface, especially a metal surface that is not otherwise coated (e.g., with an e-coat layer).

Many melt flowable materials which may be adapted for use in the present invention are readily available from commercial sources, including, for example, the injection moldable resins sold under the trade names Terostat, Terophon, and Terocore by Henkel Corporation, Madison Heights, Mich. Terostat 15103 is a preferred example of a melt flowable material suitable for use in the spacer sealant articles of the present invention.

The heat resistant polymeric spacer element of the present invention may be constructed from a material that is solid at room temperature and resistant to softening and flowing at the lowest temperature at which the sealant element softens and flows, yet is capable of being molded (e.g., injection molded) to the desired shape and configuration. Desirable characteristics of the material used for the spacer element include high heat resistance, mechanical strength, rigidity (stiffness), chemical stability, solvent/water resistance, impact resistance, electrical resistivity, dimensional stability, abrasion resistance, and/or noise and vibration dampening. The spacer element is preferably comprised of a moldable material which is sufficiently resistant to cracking and breakage during normal usage, and has a melting or softening point that is higher than both the activation temperature of the melt flowable material used in the sealant element and any bake temperature that the assembly containing the spacer sealant article will be exposed to. Preferably, the moldable material used in the spacer element is sufficiently resilient (non-brittle) and strong at ambient temperatures to withstand cracking or breaking while also being sufficiently heat resistant at elevated temperatures (e.g., the temperatures employed to cause the melt flowable material to soften and flow) to contain the melt flowable material in the desired position within the spacer sealant article. The material that comprises the spacer element is not particularly limited, and for example, may include any number of heat resistant polymers that possess these qualities (e.g., polyesters such as polyethylene terephthalate, polybutylene terephthalate, and polycyclohexylene-dimethylene terephthalate, aromatic polyethers (e.g., polyphenylene oxides), polycarbonates, polysulfones, polyimides, acetal resins, polyether ketones, polyetherether ketones and especially polyamides such as nylon 6,6). Heat resistant polymers that are suitable for use as the spacer element would be well known to those of ordinary skill in the art and include both thermoplastic and thermoset materials, and thus will not be described in detail herein. In one embodiment, the spacer element material is thermoplastic, but has a softening or melting point sufficiently high that the spacer element remains solid and non-flowing at the temperature at which the sealant element is activated (i.e., a temperature effective to cause the sealant element to soften and flow). The spacer element thus may be fabricated from a high melting point thermoplastic, such as a polyamide (nylon). To further enhance the heat resistance of the high melting point thermoplastic, the thermoplastic may be combined with one or more fillers. Inorganic (mineral) fillers, which may for example be in the form of fine particles, platelets, fibers, hollow microspheres or the like, can reduce the rate of water absorption into the spacer element and/or increase the stiffness and heat resistance of the spacer element. In a particular preferred embodiment of the invention, the spacer element is comprised of at least one glass filler, in particular glass fiber filler. Mica may also be present as a filler. Typically, the spacer element may contain a thermoplastic such as polyamide (e.g., nylon 6,6, nylon 6) or polyethylene terephthalate (PET) and, in increasing order of preference, at least 10 weight %, at least 13 weight %, at least preferably 20 weight %, at least 25 weight %, or at least 30 weight % glass fiber. Thermoplastics already formulated with glass fiber reinforcing agents are available from commercial sources, such as the PET/glass fiber materials sold under the tradename “Rynite” by E. I. duPont de Nemours. In preferred embodiments of the invention, the spacer element is a material having a heat deflection temperature at 1.80 MPa (264 psi) of at least about 150 degrees C., or at least about 175 degrees C., or at least about 200 degrees C., or at least about 220 degrees C. as measured by ASTM D648. In one embodiment, the material used to fabricate the spacer element exhibits a deformation under load (27.6 MPa/4000 psi) at 50 degrees C. of less than 1.2% or less than 1% as measured by ASTM D621. The use of a heat- and deformation-resistant spacer element provides an assembly, which is fastened together using a nut and bolt and contains a spacer sealant article as described herein, where the nut does not need to be re-torqued after baking of the assembly to activate the sealant element (i.e., the extent of torque drop as a result of heating the assembly is sufficiently low so as to provide at least the desired minimum torque level, e.g., at least about 10 or at least about 15 or at least about 20 N-m). Preferably, the amount of torque drop observed after heating is less than 50% or less than 20%.

Where the material used in the spacer element is based on a thermoplastic polymer (or blend of polymers), it is generally preferred for the thermoplastic polymer (or blend of polymers) to have a melting point or softening point (as measured by ASTM D36) greater than 200 degrees C. or greater than 225 degrees C. or greater than 250 degrees C.

The spacer element could also be fabricated using a thermosettable or crosslinkable resin such as an epoxy resin, polyester resin, or radiation-curable resin, provided the thermoset or crosslinked resin produced therefrom has the necessary heat resistance.

The materials used to prepare the spacer element and the sealant element are selected such that both elements are solid at room temperature (15 to 25 degrees C.), but with the sealant element softening and flowing at a temperature significantly below (e.g., at least 25 degrees C. below, or at least 50 degrees C. below, or at least 75 degrees C. below) the temperature at which the spacer element begins to soften.

The dimensions and shape of the spacer sealant articles of the present invention may be readily varied as desired to suit a particular end use application. For example, the thickness of the spacer element will be selected based on the desired spacing or offset between the two substrates being joined together. Typically, this thickness will be from about 0.3 mm to about 5 mm. Generally speaking, the spacer element will be uniform in thickness and substantially flat (planar), although the present invention also contemplates the use of spacer elements that are non-uniform in thickness and/or non-planar (e.g., curved, bent, angled). Preferably, the spacer element is sufficiently large (in length and width) to permit it to surround the sealant element or sealant elements that are present in the spacer sealant article. The overall size of the spacer element is also controlled so as to provide the necessary mechanical or other properties to the final assembly produced using the spacer sealant article. The shape of the spacer element may be any of a variety of shapes, including circular, rectangular, square, oval, triangular, pentagonal, hexagonal, or irregular.

The spacer element is provided with one or more through holes, which are partially filled with the sealant element or sealant elements. Each sealant element contains at least one through hole that is sufficiently large so as to permit a post (e.g., bolt) of the desired size and shape to be inserted through it. In preferred embodiments of the invention, each post is entirely surrounded by a sealant element (i.e., a portion of a sealant element is interposed between the post and the spacer element in all directions perpendicular to the longitudinal axis of the post). The through holes present in the sealant element may, for example, be circular, square, triangular, oval, hexagonal or irregular in shape. In one embodiment of the invention where the post has a circular cross-section, the through hole is a squared off circle, where the overall diameter of the circle is slightly larger than the diameter of the post but where the through hole is constricted at one point such that the width of the through hole is approximately equal to the post diameter. The constriction point helps to retain the spacer sealant article in place when the post is inserted into the through hole, thereby aiding in the assembly process.

In certain embodiments of the invention, the spacer sealer article contains one or more portions of melt flowable material in addition to the sealant element(s) surrounding the through hole(s) in the spacer element. These additional portions of melt flowable material may be integral with and/or non-integral with the sealant element(s). For example, a portion of melt flowable material may be disposed within a channel running around the periphery of one or both sides of the spacer element. In one embodiment, such portion of melt flowable material may be separate from any sealant element, but in another embodiment such portion of melt flowable material may be connected with at least one sealant element. Having such additional portion of melt flowable material disposed around the periphery of the spacer element has been found to provide a seal that is better able to exclude moisture and prevent corrosion of a metal surface that the spacer sealant article is disposed against, following heating of the sealant element(s) and such additional portion of melt flowable material.

In another embodiment of the invention, one or both of the surfaces of the spacer sealant article that will be disposed against a substrate are completely covered with a layer of melt flowable material, except for a lip of the heat resistant polymeric material used to fabricate the spacer element that extends around the outer edge of the spacer element.

The sealant element typically has approximately the same thickness as the spacer element, although in certain embodiments of the invention the sealant element thickness is somewhat greater (e.g., up to 20% greater) or somewhat smaller (e.g., up to 20% smaller) than the spacer element thickness. In one embodiment of the invention, one or both of the exposed outer surfaces of the sealant element are flush with the corresponding outer surfaces of the spacer element.

The sealant element may be retained within the spacer element by means of one or more ridges around at least a portion of the perimeter of said sealant element that extend into or over the spacer element. The through hole in the spacer element may, for example, be notched or curved (in a concave or convex manner, for instance) so that when the sealant element is inserted or formed within such through hole it is held in place by means of a mechanical interlocking. Retention of the sealant element within the spacer element may also be assisted by adherence of the materials used to fabricate these two elements. That is, the outer edge(s) of the sealant element may be bonded to the edge(s) of the through hole in the spacer element, thereby reducing the tendency of the sealant element to separate from the spacer element.

The spacer sealant articles of the present invention may be readily and conveniently produced by molding techniques, especially injection molding methods such as insert molding, co-molding, overmolding and multiple material molding (also known as two shot or multi-shot molding). For example, the spacer element may first be fabricated by injection molding using a suitable material such as a glass fiber-filled polyamide or polyethylene terephthalate. Granules of the suitable material may be placed into a hopper which feeds into a heated injection unit. A reciprocating screw pushes the granules through a heating chamber, where the granules are softened to a flowable state. At the end of this chamber there is a nozzle which abuts firmly against an opening into a relatively cool, closed mold having a cavity with the same dimensions as the desired spacer element. The heated material is forced at high pressure through the nozzle into the mold cavity. A series of clamps holds the mold halves together. Once the material has cooled to a solid state, the mold is opened and the injection molded spacer element ejected. The spacer element may thereafter be placed in another mold such that a cavity having the desired dimensions of the sealant element is created. The spacer element assists in defining such cavity; for example, the walls of the through hole in the spacer element help to contain the melt flowable material selected for use in forming the sealant element when it is heated and injected into the cavity. Portions of the spacer element may be encapsulated by the melt flowable material (for example, a ridge extending from the perimeter of the through hole). After cooling to resolidify the melt flowable material, the mold is opened and the spacer sealant article removed.

A spacer sealant article in accordance with the present invention may contain one, two, three or more sealant elements embedded within a single spacer element. Each sealant element may contain one, two, three or more through holes therein. If multiple through holes are to be provided in a single spacer sealant article, it will often be advantageous to employ a single sealant element incorporating all the through holes. Such an arrangement facilitates manufacture of the spacer sealant article where injection molding (e.g., overmolding) is utilized, as the melt flowable material used to form the sealant element may be injected into the mold at a single point.

The spacer sealant articles of the present invention may be advantageously used in an assembly process using any of a variety of substrates, including metallic, plastic, as well as composite or laminate substrates. For example, one or both of the substrates to be joined together may be comprised of metal or metal alloy, such as steel. The surface of the metallic substrate(s) may be treated prior to being assembled with the spacer sealant article; such pretreatments may include one or more of cleaning, conversion coating, plating, priming, painting or the like.

In one embodiment of the invention, a substrate having a base is employed where at least one post extends from the base, with the at least one post extending through a through hole in the spacer sealant article. This post may be integral with or separate from the substrate having the base. For example, the post may be a bolt which is initially separate from the substrate and which is inserted into a through hole in the substrate. The post may be comprised of the same material as the substrate or a different material, e.g., the post may be metallic or plastic. In one embodiment, the post may be a metal bolt having a head at one end which is larger in diameter than the diameter of the remainder of the bolt and a thread at its other end capable of receiving a threaded nut.

The present invention finds particular utility in the manufacture of motor vehicles, in particular where a hinge is being used to attach a door, liftgate, hood, trunk or the like to the vehicle body. For example, one substrate may be a hinge or hinge component (e.g., a hinge bracket) and the other substrate may be a section or area of the vehicle body such as a door or roof pillar. However, other suitable end-use applications include appliances, building components (e.g., doors, windows), machinery, aircraft, ships, and the like.

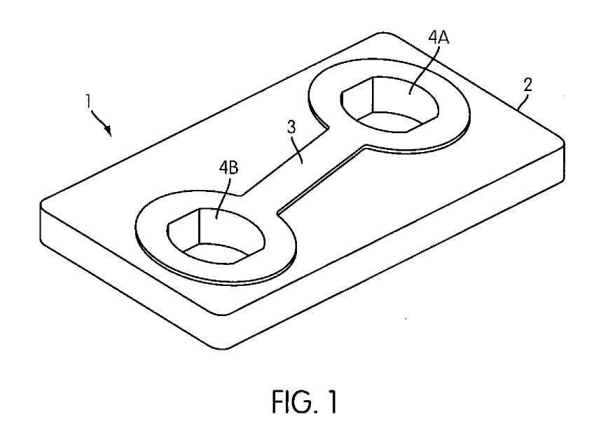

FIG. 1 illustrates one embodiment of a spacer sealant article (1) in accordance with the present invention. The spacer sealant article (1) is comprised of a spacer element (2), which may be fabricated (by injection molding, for example) from a heat-resistant material such as a glass fiber-filled polyamide. The spacer element (2) surrounds a sealant element (3), which may be fabricated (through overmolding onto the spacer element, for example) from a thermoplastic having a softening temperature lower than that of the spacer element (2). In this particular embodiment, the sealant element (3) is in the form of a “dumbbell” having two ends that are larger in diameter than the center section of the sealant element (3). A through hole (4A, 4B) is present at each end of the sealant element (3). As shown here, the thickness of the sealant element (3) is slightly greater than the thickness of the spacer element (2). The through holes (4A, 4B) are sufficiently large in diameter to permit bolts of the desired size and shape to be inserted into the through holes. Although the spacer element effectively surrounds the sealant element, a surface of the sealant element remains exposed on each side of the spacer sealant article.

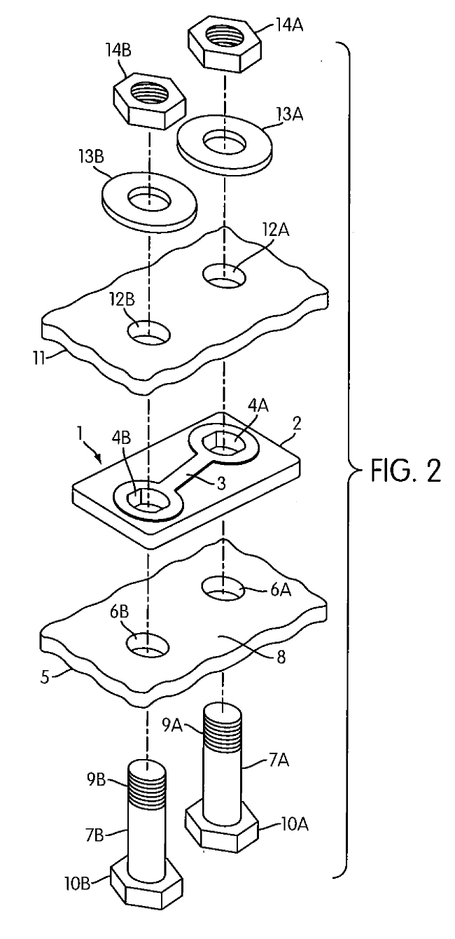

FIG. 2 illustrates how the spacer sealant article (1) of FIG. 1 can be utilized in joining a first substrate (5) to a second substrate (6). FIG. 2 further illustrates how portions of the sealant element will surround a bolt inserted through a through hole in the sealant element, thereby separating the bolt from the spacer element. The first substrate (5) contains two through holes (6A, 6B) and a base (8). A bolt (7A) having a threaded end (9A) and a hex-shaped head (10A) at its other end is inserted into through hole (6A) in the first substrate (5). Another bolt (7B) having a threaded end (9B) and a hex-shaped head (10B) is similarly inserted into through hole (6B). Bolts (7A, 7B) may optionally be permanently attached to first substrate (5) by welding or other such means. The threaded end (9A) of bolt (7A) extends from base (8) through through hole (4A) of the spacer sealant article (1) and through through hole (12A) of second substrate (6). Likewise, the threaded end (9B) of bolt (7B) extends from base (8) through through hole (4B) of the spacer sealant article (1) and through through hole (12B) of second substrate (6). Washers (13A, 13B) and nuts (14A, 14B) are then used to secure the assembly (15) together by threading nuts (14A, 14B) onto threaded ends (9A, 9B).

In many applications where the spacer sealant article of the present invention is used in a process where two substrates are joined together, it will be desirable to maintain a certain minimum torque on the nuts used to secure the bolts in the assembly. Typically, the nuts are tightened initially at room temperature before subjecting the assembly containing the spacer sealant article to heat in order to activate the sealant element. If the spacer element is not sufficiently heat-resistant, the torque on the nuts may drop below the desired minimum level due to distortion of the spacer element, thereby requiring the nuts to be re-tightened. As this adds an additional step to the overall assembly process, it will therefore be advantageous to utilize a material to fabricate the spacer element that does not exhibit an unacceptable degree of torque drop upon heating.

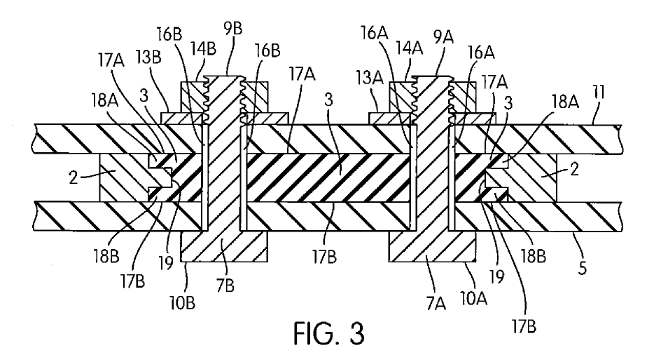

FIG. 3 is a cross-sectional representation (along the longitudinal axis of the sealant element) of the assembly (15) after tightening nuts (14A, 14B) onto the threaded ends (9A, 9B) of bolts (7A, 7B) and before activation of the sealant element (3) by heating. Although the sealant element (3) is surrounded by the spacer element (2), surfaces (17A, 17B) of the sealant element (3) remain exposed and thus can be brought into contact with the inwardly facing surfaces of the first substrate (5) and second substrate (6). As shown in FIG. 3, the sealant element (3) is the same thickness as the spacer element, but to ensure good contact of surfaces (17A, 17B) of the sealant element (3) with the substrate surfaces the sealant element (3) thickness may be somewhat greater than the spacer element (2) thickness. Small gaps (16A, 16B) are present between the bolts (7A, 7B) and the sealant element (3). When the assembly (15) is heated, the sealant element softens and/or flows and/or expands to bridge gaps (16A, 16B), thereby effectively forming a water-tight seal around the bolts (7A, 7B). The gaps between the bolts (7A, 7B) and the first substrate (5) and between the bolts (7A, 7B) and the second substrate (6) may also be at least partially filled by the sealant element (3) once it has been activated by heating, particularly if the sealant element (3) is expandable (e.g., is formulated to contain one or more blowing agents). FIG. 3 also illustrates how the sealant element (3) may be retained within the spacer element (2) using ridges (18A, 18B) around the perimeter of the sealant element (3) that extend over a portion (19) of the spacer element (2).

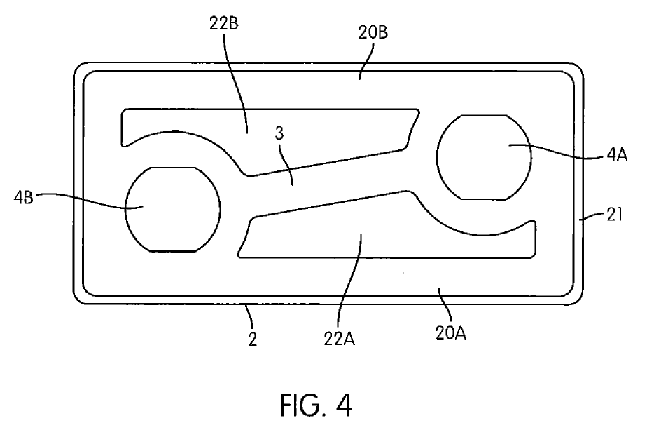

FIG. 4 illustrates another embodiment of a spacer sealant article (1) in accordance with the present invention. The spacer sealant article (1) is comprised of a spacer element (2), which may be fabricated (by injection molding, for example) from a heat-resistant material such as a glass fiber-filled polyamide. The spacer element (2) surrounds a sealant element (3), which may be fabricated (through overmolding onto the spacer element, for example) from a melt flowable material containing a thermoplastic having a softening temperature lower than that of the spacer element (2). In this particular embodiment, the sealant element (3) is in the form of a “dumbbell” having two ends that are larger in diameter than the center section of the sealant element (3). In addition, further portions (20A, 20B) of the melt flowable material extend integrally from the ends of the sealant element (3) around the periphery of the spacer element (2). For example, a peripheral channel may be formed in the spacer element (2) such that when the melt flowable material is overmolded onto the spacer element (2) it fills the peripheral channel. A relatively narrow lip or rim (21) of the heat resistant polymer used to prepare the spacer element thus is present along the entire perimeter of the spacer sealant article. Additionally, “islands” (22A, 22B) of the heat resistant polymer are present which are surrounded by the melt flowable material. The opposite side of the spacer sealant article may have a similar arrangement, which helps to ensure a good seal against the substrate surfaces to be joined once the melt flowable material is activated while still maintaining the desired spacing between the substrates due to the heat resistance and stiffness of the spacer element and also preventing the melt flowable material from being visible. A through hole (4A, 4B) is present at each end of the sealant element (3). The through holes (4A, 4B) are sufficiently large in diameter to permit bolts of the desired size and shape to be inserted into the through holes. Although the spacer element effectively surrounds the sealant element, a surface of the sealant element remains exposed on each side of the spacer sealant article.

In yet another embodiment of the invention, a layer of the melt flowable material may extend out integrally from along the entire length of the sealant element so to cover the entire face of the spacer element, except for a peripheral lip.

What is claimed is:

1. A spacer sealant article comprising a) a heat resistant polymeric spacer element and b) at least one sealant element surrounded by said spacer element, wherein said at least one sealant element has at least one through hole therein.

2. An article in accordance with claim 1, wherein said spacer element is comprised of a thermoplastic polymer, and optionally a filler.

3. An article in accordance with claim 1, wherein said spacer element is comprised of a thermoplastic polymer having a melting or softening point of at least 225 degrees C.

4. An article in accordance with claim 1, wherein said spacer element is comprised of glass-filled polyimide.

5. An article in accordance with claim 1, wherein said sealant element has at least two through holes therein.

6. An article in accordance with claim 1, wherein said sealant element softens and flows at a temperature within the range of from 100 degrees C. to 200 degrees C.

7. An article in accordance with claim 1, wherein said spacer element does not soften and flow at a temperature less than 200 degrees C.

8. An article in accordance with claim 1, wherein said spacer element exhibits a deformation under load at 122 degrees F. of less than 1% and a heat deflection temperature at 264 psi of at least 400 degrees F.

9. An article in accordance with claim 1, wherein said sealant element softens and flows at a temperature at least 25 degrees C. lower than the minimum temperature at which the spacer element softens and flows.

10. An article in accordance with claim 1, wherein said sealant element is heat expandable.

11. An article in accordance with claim 1, wherein said sealant element is comprised of at least one thermoplastic polymer.

12. An article in accordance with claim 1, wherein said spacer element and said sealant element are essentially equal in thickness.

13. An article in accordance with claim 1, wherein said sealant element has been overmolded onto said spacer element.

14. An article in accordance with claim 1, wherein said article has been obtained by insert molding, with said spacer element being used as an insert.

15. An article in accordance with claim 1, wherein said article has been obtained by co-molding.

16. An article in accordance with claim 1, wherein said sealant element is retained within said spacer element by means of one or more ridges around at least a portion of the perimeter of said sealant element that extend into or over said spacer element.

17. An article in accordance with claim 1, wherein said spacer element is comprised of a thermoplastic polymer or blend of thermoplastic polymers having a melting or softening point of greater than 200 degrees C.

18. An assembly comprised of a spacer sealant article in accordance with claim 1 and a substrate having a base and at least one post extending from said base, wherein said at least one post extends through said at least one through hole.

19. An assembly in accordance with claim 18, wherein said substrate is selected from the group consisting of hinge brackets, fuel cap brackets, seat belt brackets and seat mounting brackets.

20. An assembly in accordance with claim 18, wherein said article has a surface which substantially conforms to a surface of said base and wherein said surface of said article is in contact with said surface of said base.

21. An assembly in accordance with claim 18, additionally comprising a second substrate having a through hole therein, wherein said at least one post extends through said through hole of said second substrate and said article is between said substrate and said second substrate.

22. A method of fastening a first substrate to a second substrate, said method comprising:
a). providing said first substrate with at least one post extending therefrom;
b). providing said second substrate with at least one through hole;
c). providing an article comprising i) a heat resistant polymeric spacer element and ii) a sealant element surrounded by said spacer element, wherein said sealant element has at least one through hole therein;
d). inserting said at least one post through said at least one through hole of said article and said at least one through hole of said second substrate;
e). bringing said first substrate, said article and said second substrate into close conformance with each other; and
f). heating said sealant element to a temperature effective to cause said sealant element to soften and flow, said temperature being selected so as to avoid softening of the spacer element.

23. A method in accordance with claim 22, wherein said at least one post is a threaded bolt and step e) is accomplished by tightening at least one nut onto said threaded bolt.

24. A method in accordance with claim 22, wherein said sealant element softens and flows so as to seal around said post where said post extends through said sealant element.
